(19) United States
(12) Patent Application Publication
(10) Pub. No.: US 2004/0098894 A1
(43) Pub. Date: May 27, 2004

(54) Illuminated signaling device

(76) Inventor: Ivia V. Thomas, Brooklyn, NY (US)

Correspondence Address: Rashida A. Karmali, Esq., 99 Wall Street, 13th Floor, New York, NY, 10005, US

(21) Appl. No.: 10/301,250

(22) Filed: Nov. 21, 2002

(51) Int. Cl. G09F 21/02; G09F 13/04

(52) U.S. Cl. 40/586; 40/564

(57) ABSTRACT

The present invention relates to portable signaling devices used for attracting attention and/or signaling messages. The devices are made of fluorescent material which illuminates brightly with a battery operated light, to display a variety of signals, logos, legends, messages and the like, to attract attention to the user. The present invention is to aide pedestrians in need of transportation, especially in urban city settings, to display a variety of signals to attract attention to themselves to hail a vehicle, while maintaining their safety.

### FIELD OF THE INVENTION

This invention relates to portable, practically useful devices that are used in general, for attracting attention and/or signaling messages. More particularly, the devices are made of fluorescent material which illuminates brightly with a battery operated light, and thus allows the user to display a variety of signals, logos, legends, messages and the like, to attract attention to the user. The goal of the present invention is to aide individuals, especially in urban city settings, to display a variety of signals to attract attention to themselves, while maintaining their safety. Specifically, the present invention fulfills the need of city dwellers, pedestrians and people in general who are in need for transportation to go from one point to another, and who desire to hail the driver of a transportation vehicle, for a ride.

### BACKGROUND TO THE INVENTION

Currently, it is extremely difficult for a pedestrian to be noticed when hailing for a taxi or cab or any vehicle without endangering the pedestrian's safety by proceeding dangerously close to oncoming traffic. The problem is greatly magnified, for example, when the weather conditions are worsened during rainy, clouded days or by poorly streets at night.

Previously relevant prior art teaches various portable illuminated devices which were used to attract attention by pedestrians attempting to hail a taxi. For example, U.S. Pat. No. 4,601,120 issued on Jul. 22, 1986 to Levin, describes a sign attached to an umbrella or garment, for use by an individual whose hands are otherwise occupied. This device is used solely as a device attached to a larger structure and not as an individual entity in and of it self, and moreover, the larger structure used to mount the device is not illuminated. Therefore, this device was not very useful in attracting attention by pedestrians or other users, in busy urban streets during heavy traffic.

GB Patent No. 2,181,290A describes a marshelling and signaling device in the form of a hand glove that is made of two or more sheets made of a special reflective material. These sheets may be welded together or may contain a stiffening means between them to extend them to the signaling area. This device was developed to be waved by hand to provide visible signals, for example in the control of road traffic or by ground aircraft crew.

U.S. Pat. No. 5,276,424 describes a flashing sign for use as a means to regulate traffic by law enforcement personnel or road traffic officers, for example, by using signs reading legends such as STOP or YIELD. the sign housing includes two flat surfaces which contain the appropriate legends and have on the flat surfaces at least two light emitting areas, composed of windows having quartz or high intensity bulbs. This device is clearly unsuitable for daily use by a pedestrian.

Although the above mentioned prior art devices include a number of signaling means, none of the devices described can be used by a pedestrian seeking to attract attention of a taxi driver speeding by in busy traffic conditions, for example, when looking for a taxi on the street during night time or during raining weather conditions when visibility is poor. Even the trained eyes of an experienced urban taxi driver require attracting attention by some means—usually, the pedestrian hurling dangerously forward onto the road just to be noticed. It is therefore the objective of this invention to provide a portable, practically useful and easily operated device which can generate illuminated signals, in colors that are not mistaken by the traffic light colors of green, red and amber. The present invention comprises of a device that may be used in other situations besides stopping a taxi or other vehicle, by using logos, legends, signs, graphics, messages and the like to attract attention, to receive service, to express a sentiment, all while maintaining the user's safety. of the user.

### SUMMARY OF THE INVENTION

The present invention relates to a portable signaling device for use by an individual to attract attention in order to communicate a desired message to another individual, for example, a taxi driver, an occupant of any moving vehicle, a captain of a ferry boat, and the like, while remaining in safety despite any conditions of danger or hazard in the environment. The present invention is a general approach for an individual to attract attention using a cost effective device, easily portable, easily operable and easily carried, in conditions that are prevalent in most peoples' lives, such as busy traffic congested urban cities, night time when streets are poorly lit, and in conditions of poor visibility, by use of an illuminated device displaying a legend, logo or message on a fluorescent material that is brightly illuminated by a battery powered light.

The portable signaling device of the present invention includes a support with a handle portion housing a battery powered source of power and a bulb, and a fluorescent material which is foldable along a plurality of predefined seams.

A plurality of individual sheets of fluorescent material are provided, each of the sheets displaying a selected message, each of the messages being presented according to a selected command, legend, logo, request, message or content.

In yet another embodiment, the present invention is directed to a signaling device wherein each of the display portion of the fluorescent materials has affixed on it, a plurality of notches or markers at suitable positions, such notches or markers being used for affixing removable display sheets carrying selected messages with nonfluorescent lettering to make the signs even more striking.

In preferred embodiments, the display portion and messages supported thereon are of a sufficient size and dimention so that content of the messages are easily visible to induce a response to the sign.

Accordingly, it is the object of the present invention to allow pedestrians to attract attention of oncoming motorists without having to put themselves in danger or hazard by standing dangerous in the path of oncoming traffic.

It is further an object of the present invention to provide an affordable, portable signaling device which is discernable to motorists and pedestrians and is different and distinguishable from any of the other light signals currently in use, such as the red harard lights, the red, green and amber traffic lights and the like. The present invention allows the user to have a choice colors, for example, a preferred one being a magenta bright blue, to illuminate the different signaling devices and be eventually recognized every where as the light that signals a pedestrain's or public's message or call.

It is also within the scope of this invention to provide a choice of illuminated signaling devices that are easy to use, that are affordable and most of all, that increase safety for the public. be removeably attached to the display sheet via a series of notches or markers 20. The portable signaling device according to claim 1, wherein said display portion further comprising means for mounting a message bearing sheet made of non-fluorescent material, wherein the mounting means include a plurality of notches or markers.

Thus, a portable signaling device powered by batteries and foldably stored as a pocket sized device by an individual, has been shown in the first embodiment.

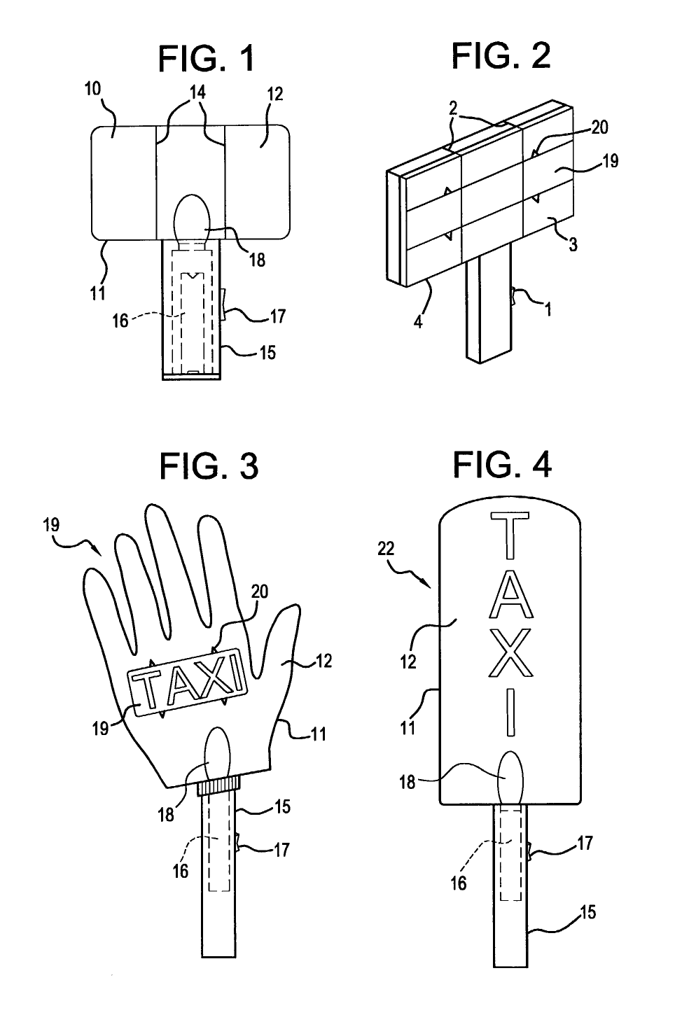

FIG. 3 shows the second embodiment of the system 21 referred to as a “CABBIE CALLER” representing a portable signaling device in the shape of a hand or glove and carrying the indicia “TAXI”. The advantage of this embodiment is that the user can light up the signal and simulate a hand waving to attract attention. Elements of this embodiment that are similar to corresponding elements in the first embodiment have been assigned similar numerical units.

FIG. 4 shows the third embodiment of the invention, also referred to as a CABBIE CALLER, representing a portable signaling device in the shape of a baton 22. The portable signaling device according to claim 1, wherein said display portion is in shape comprising a hand, glove, rectangle, square, diamond, oblong or fan.

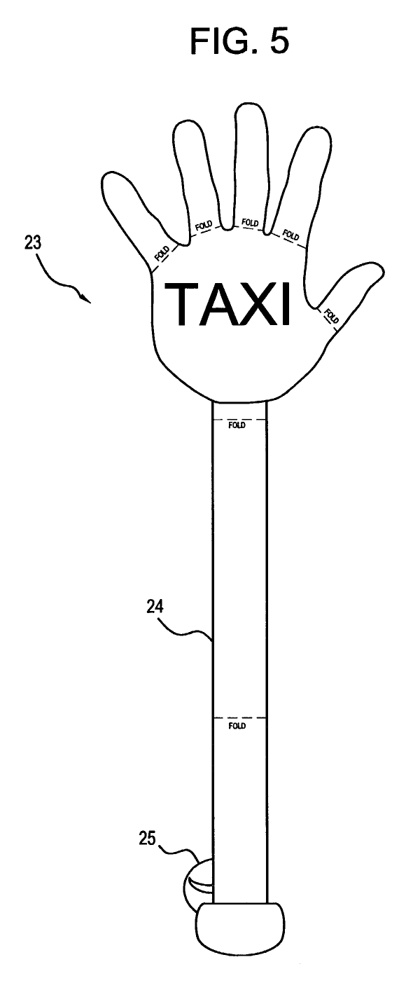

FIG. 5 shows the fourth embodiment of the invention, representing a “DOORMAN'S CABBIE CALLER” 23 including a foldable hand shaped portion similar to the embodiment described in FIG. 3, attached to the end of a collapsible rod 24, said rod being controlled by a spring lever 25. The handle portion is constructed of a length in the range of about twelve inches to about forty eight inches when extended and the hand held end of the handle is bound to a spring release hinge capable of collapsing the handle to a substantially shorter length.

The portable signaling device of the present invention includes a handle portion and the display portion comprise of material including plastics, polymers or plasticized resins. The portable signaling device has a display portion carrying messages, wherein each of said messages being presented is of a selected content, color or lettering style. The portable signaling device of the present invention, has a display portion is made of a fluorescent material capable of being illuminated by the selected color of light source.

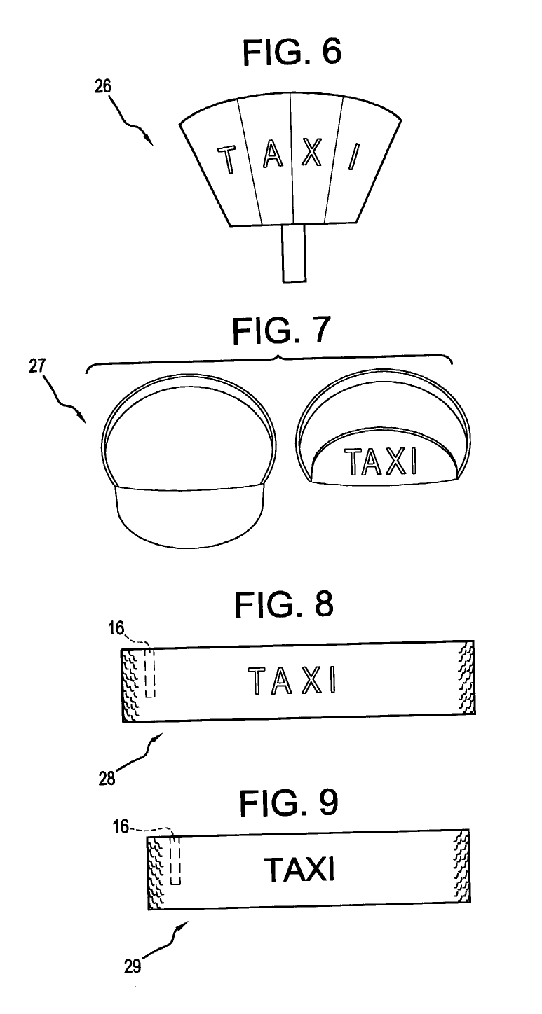

FIG. 6 shows the fifth embodiment of the invention, representing a CABBIE CALLER in the shape of a Chinese fan 26. This device is designed just as the Chinese fan so that the device may be folded into a narrow collapsible signaling device that is easy to carry and store.

FIG. 7 shows the sixth embodiment of the invention representing a signaling device in the form of a “SUN VISOR” on a cap 27.

FIG. 8 shows the seventh embodiment of the invention in the form of a head band 28 having all of the essential elements.

FIG. 9 shows the eighth embodiment of the invention in the form of a hand band 29 and having all of the essential elements.

Thus, a cost effective, portable, easily operable illuminated signaling device powered by a battery source is described.

The present invention is not to be limited in scope by the embodiment disclosed in the example which is intended as an illustration of one aspect of the invention and any methods which are functionally equivalent are within the scope of the invention. Indeed, various modifications of the invention in addition to those shown and described herein will become apparent to those skilled in the art from the foregoing description. Such modifications are intended to fall within the scope of the appended claims.

Those skilled in the art will recognize, or be able to ascertain using no more than routine experimentation, any equivalents to the specific embodiments of the invention described herein. Such equivalents are intended to be encompassed by the claims.

What is claimed is:

1. A portable signaling device for displaying changeable messages, said device comprising:
a support including a handle portion and an interconnecting planar display portion,
said handle portion having a battery driven source of light controlled by a switch,
said display portion having a first surface and a second oppositely facing surface defining there between a specified thickness, wherein said surface and second surface display a selected message thereof.

2. The portable signaling device according to claim 1, wherein said display portion further comprising means for mounting a message bearing sheet made of non-fluorescent material, wherein the mounting means include a plurality of notches or markers.

3. The portable signaling device according to claim 1, said display portion further comprising a plurality of seams to permit folding said device into a pocket sized portable device.

4. The portable signaling device according to claim 1, wherein said display portion is in shape comprising a hand, glove, rectangle, square, diamond, oblong or fan.

5. The portable signaling device according to claim 1, wherein the handle portion and the display portion comprise of material including plastics, polymers or plasticized resins.

6. The portable signaling device according to claim 1, wherein each of said messages being presented is of a selected content, color or lettering style.

7. The portable signaling device according to claim 6, wherein the display portion is made of a fluorescent material capable of being illuminated by the selected color of light source.

8. The portable signaling device according to claim 1, wherein the handle portion is constructed of a length in the range of about twelve inches to about forty eight inches when extended and the hand held end of the handle is bound to a spring release hinge capable of collapsing the handle to a substantially shorter length.

9. A portable signaling device for displaying changeable messages comprising a support including a display portion and a battery driven source of light, wherein the display portion is a head band, a hand band or a cap visor.
